(19) United States
(12) Patent Application Publication
(10) Pub. No.: US 2017/0162969 A1
(43) Pub. Date: Jun. 8, 2017

(54) TERMINAL PAIR AND CONNECTOR

(71) Applicants: AutoNetworks Technologies, Ltd., Yokkaichi (JP); Sumitomo Wiring Systems, Ltd., Yokkaichi (JP); SUMITOMO ELECTRIC INDUSTRIES, LTD., Osaka-shi (JP)

(72) Inventor: Takahito Jou, Yokkaichi (JP)

(21) Appl. No.: 15/350,222

(22) Filed: Nov. 14, 2016

(30) Foreign Application Priority Data
Dec. 8, 2015 (JP) 2015-239566

(51) Int. Cl. H01R 13/03; H01R 13/11

(52) U.S. Cl. CPC H01R 13/03; H01R 13/11

(57) ABSTRACT

A terminal pair (1) includes a female terminal (10) with a second contact piece (33) and a male terminal (20) provided with a tab (21). The female and male terminals (10, 20) are connected electrically by a bulging contact portion (33A) on the second contact piece (33) contacting a contact region (21A) on the lower surface of the tab (21). An outermost surface of a contact part of the bulging contact portion (33A) narrower than the contact region (21A) is coated with a first silver plating layer (53), and an outermost surface of the contact region (21A) is coated with a second silver plating layer (43) having a lower Vickers hardness than the first silver plating layer (53).

### BACKGROUND

1. Field of the Invention

The invention relates to a terminal pair and a connector provided with the same.

2. Description of the Related Art

A connector used for a vehicle conventionally has a terminal pair that includes a male terminal and a female terminal. The male terminal is inserted into the female terminal and contacts a contact portion of the female terminal with a predetermined contact pressure to electrically connect the male and female terminals. Such a connector may be used in a high vibration environment, such as an engine compartment. In this situation, the vibration of a vehicle is transferred to terminal connecting portions and contact parts of the terminals slide on each other. As a result, contact parts of the terminals are abraded to increase resistance or cause a connection failure.

Some connectors provide a backlash preventing projection between a female connector housing that holds the female terminal and a male connector housing that holds the male terminal. These connectors reduce the influence of vibration in a direction perpendicular to a terminal inserting direction, but are not very effective for vibration in the terminal inserting direction. Japanese Unexamined Patent Publication No. 2012-18765 discloses a connector that fixes a female connector housing and a male connector housing in an inserting direction by operating a lever on the connector housing. However, the connector disclosed in Japanese Unexamined Patent Publication No. 2012-18765 has problems. In particular, the connector housing is costly, the entire connector is enlarged due to the space required for the lever, and the lever complicates the connection process.

The invention was completed based on the above situation and aims to provide a terminal pair and a connector that are high in vibration resistance, excellent in connection reliability and simply configured.

### SUMMARY

The invention relates to a terminal pair that includes a first terminal provided with a contact portion, and a second terminal with a contact region wider than the contact portion. The contact portion of the first terminal contacts the contact region of the second terminal to connect the first and second terminals to each other electrically. An outermost surface of the contact portion is coated with a first plating layer, and an outermost surface of the contact region is coated with a second plating layer having a lower Vickers hardness than the first plating layer.

As described in this specification, the contact region is a region of the second terminal that can contact the contact portion of the first terminal. The contact portion slides in the contact region when the vibration of a vehicle is transferred to the above-described terminals. The first plating layer is formed on the contact portion of the first terminal, which has a narrower area of contact than the contact region on the second terminal. Additionally, the first plating layer has a higher Vickers hardness than the second plating layer and therefore is unlikely to be abraded. Consequently, electrical connection between the first and second plating layers can be maintained, and electrical conductivity between the terminals is kept for a long period of time.

The above-described terminal pair has a high vibration resistance, excellent connection reliability and a simply configuration. Additionally, the terminal pair does not require a drastic cost increase or a shape change and achieves the advantages by simply adjusting the hardness of the plating layer that coats the outermost surface of each terminal in a terminal pair that has a conventional structure.

Metals that form the first and second plating layers may be one, two or more kinds of metals selected from a group consisting of silver, gold and palladium or alloys thereof. Silver, gold and palladium and their alloys are relatively difficult to oxidize. By using these metals or alloys as the metals of the first and second plating layers, even if one or both of the first and second plating layers are abraded, abrasion powder of these metals or alloys can be present between the contact portion and the contact region without being oxidized. The abrasion powder can maintain the electrical connection between the contact portion and the contact region, thereby further improving the connection reliability of the terminal pair.

In one embodiment, the metal forming the first and second plating layers is silver or silver alloy.

Tin, silver or gold plating generally is applied to terminals used in connectors for vehicle and the like in view of various properties. Among these metals, silver has a particularly high adhesion property. Thus, even if a terminal having an outermost surface coated with a silver plating layer slides on a contact part and the silver plating layer is peeled partly off by abrasion, most of produced silver abrasion powder tends to stay on the contact part such as by adhering to the silver plating layer remaining on the terminal surface.

According to the above configuration, when the vibration of a vehicle is transferred to the terminals and the contact portion slides in the contact region, the second plating layer of the contact region is abraded earlier than the first plating layer of the contact portion. The silver powder produced by this abrasion can stay in the contact region, fill up abrasion marks of the second plating layer and be present between the contact portion and the contact region, such as by adhering to the first plating layer on the lower surface of the contact portion due to a high adhesion property of silver. Silver is difficult to oxidize. Thus, the silver abrasion powder remains without being oxidized and a high conductivity is maintained. The silver abrasion powder remaining on the contact part protects the first plating layer of the contact portion and also keeps a high electrical conductivity between the terminals for a long period of time. In this way, the electrical connection reliability of the terminal pair can be improved further.

A difference between a Vickers hardness of the first plating layer and that of the second plating layer can be about 10 Hv or more. Further, the Vickers hardness of the first plating layer may be about 110 Hv or higher and that of the second plating layer may be about 110 Hv or lower. These configurations suppress a situation where the first plating layer is abraded earlier than the second plating layer and reliably obtain the aforementioned effects.

The contact portion may be in line or point contact with the contact region when the first and second terminals are connected to each other. Thus, the contact portion easily is abraded locally since the contact portion is significantly smaller than the contact region and a contact failure and the like due to abrasion are likely to occur. Thus, the technique disclosed in this specification is more useful.

The second terminal may be a male terminal including an insertion piece provided with the contact region, and the first terminal may be a female terminal including a resilient piece provided with the contact portion. The insertion piece may be insertable into the female terminal, and the resilient piece may resiliently contact the insertion piece inserted into the female terminal. Thus, the first and second terminals slide easily while held resiliently in contact.

The first plating layer and/or the second silver plating layer may have a thickness in the range of about 1 to about 10 μm.

The invention also relates to a connector provided with the above-described terminals. More particularly, the connector may include a first connector housing configured to accommodate the first terminal, and a second connector housing connectable to the first connector housing and configured to accommodate the second terminal.

According to the technique described in this specification, it is possible to provide a terminal pair and a connector which are high in vibration resistance, excellent in connection reliability and simply configured.

These and other features of the invention will become more apparent upon reading the following detailed description and accompanying drawings. It should be understood that even though embodiments are described separately, single features may be combined to additional embodiments.

### BRIEF DESCRIPTION OF THE DRAWINGS

FIG. 1 is a section showing contact parts of a male terminal and a female terminal in a terminal pair according to one embodiment.

FIG. 2A is a cross-sectional view of contact parts in a terminal pair including a contact portion and a contact region coated with a silver plating layer harder than a silver plating layer on the contact portion as a comparative embodiment.

FIG. 2B is a cross-sectional view of an inferred state of the silver plating layers and silver abrasion powder after the terminals held in contact in the contact parts of FIG. 2A are caused to slide.

FIG. 2C is a cross-sectional view of an inferred state of the silver plating layers and the silver abrasion powder after sliding is further repeated from the state of FIG. 2B

FIG. 3A is a cross-sectional view of contact parts of a male terminal and a female terminal.

FIG. 3B is a cross-sectional view of an inferred state of silver plating layers and silver abrasion powder after the terminals held in contact in the contact parts of FIG. 3A are caused to slide.

FIG. 3C is a cross-sectional view of an inferred state of the silver plating layers and the silver abrasion powder after sliding is further repeated from the state of FIG. 3B.

FIG. 4 is a diagram showing the summary of a sliding abrasion durability test.

FIG. 5 is a graph showing transitions of resistance measured in the sliding abrasion durability test.

### DETAILED DESCRIPTION

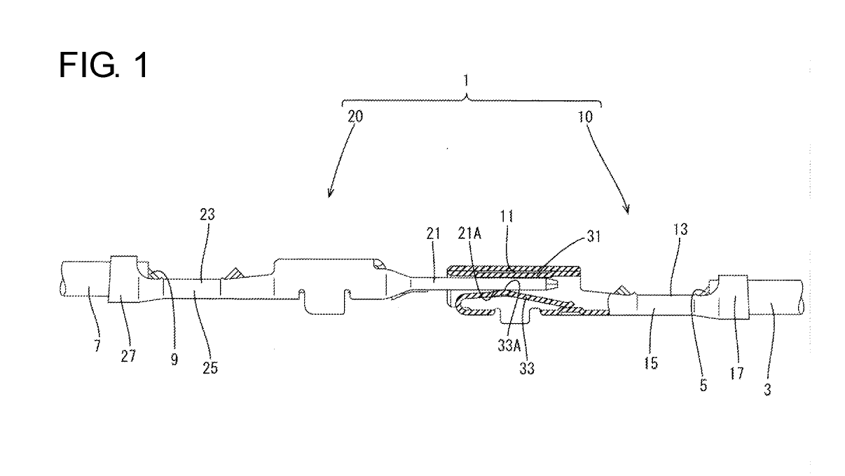

One embodiment is described with reference to FIGS. 1 to 3. As shown in FIG. 1, a terminal pair 1 according to this embodiment includes a female terminal 10 (first terminal) and a male terminal 20 (second terminal). In the following description, upper and lower sides and left and right sides in FIG. 1 are respectively referred to as upper and lower sides and left and right sides, and sides of the female terminal 10 and the male terminal 20 substantially facing each other are referred to as front ends (opposite sides are rear ends). Note that vertical and lateral directions are defined for the convenience of description and the terminal pair 1 can be used in an arbitrary posture.

### [Structure of Terminal Pair]

### (Female Terminal 10)

The female terminal 10 is formed by shaping (e.g. press-working, embossing, bending, folding, cutting and the like) an electrically conductive metal plate material including a female terminal base material 51 into a predetermined shape. A first silver plating layer 53 (an example of a first plating layer) is formed on outermost surfaces of the female terminal 10 as described later. As shown in FIG. 1, the female terminal 10 includes a connecting tube 11 into which a tab 21 of the male terminal 20 to be described later is to be inserted, and a wire connecting portion 13 connected to and behind the connecting tube 11. The female terminal 10 is electrically connected to a wire 3 by crimping a wire barrel 15 to a core 5 exposed at an end of the wire 3 and crimping an insulation barrel 17 to the wire 3 in the wire connecting portion 13.

The connecting tube 11 is a substantially rectangular or polygonal tube and a first contact piece 31 and a second contact piece 33 are provided in or at the connecting tube 11. As shown in FIG. 1, the first contact piece 31 is formed by striking or embossing the ceiling surface of the connecting tube 11 substantially in or down. When the tab 21 of the male terminal 20 is inserted to a predetermined position, a part of the lower surface of the first contact piece 31 comes into surface contact with the upper surface of the tab 21. On the other hand, the second contact piece 33 is formed as a resiliently deformable resilient contact piece by bending an extended part of the bottom surface of the connecting tube 11 at a plurality of positions. A bulging contact portion 33A set at a distance shorter than a thickness of the tab 21 from the lower surface of the first contact piece 31 in a natural or undeformed state is formed on the upper or inner surface of the second contact piece 33.

### (Male Terminal 20)

The male terminal 20 is formed by shaping (e.g. press-working, embossing, bending, folding, cutting and the like) an electrically conductive metal plate material including a male terminal base material 41 into a predetermined shape. A second silver plating layer 43 (an example of a second plating layer) is formed on outermost surfaces of the male terminal 20 as described later. As shown in FIG. 1, the male terminal 20 includes the tab 21 in the form of a wide flat plate extending in a front-back direction. The male terminal 20 is connected electrically to a wire 7 by crimping a wire barrel 25 to a core 9 exposed at an end of the wire 7 and crimping an insulation barrel 27 to the wire 7 in a wire connecting portion 23.

### (Electrical Connection Structure)

To electrically connect the terminals of the terminal pair 1 structured as described above to each other, the tab 21 of the male terminal 20 is inserted into the female terminal 10 while the second contact piece 33 is resiliently deformed to pressingly widen a distance between the first contact piece 31 and the bulging portion 33A. The inserted tab 21 is biased in or up towards the first contact piece 31 by the bulging portion 33A of the second contact piece 33 being resiliently restored, pressed against the first contact piece 31 and sandwiched between the first and second contact pieces 31, 33. In this way, the upper surface of the tab piece 21 comes into surface contact with the inner or lower surface of the first contact piece 31 and a contact region 21A on the lower surface of the tab piece 21 comes into contact with the bulging contact portion 33A of the second contact piece 33 so that the female terminal 10 and the male terminal 20 are connected electrically. Note that the contact region 21A is a region of the lower surface of the tab 21 which can contact the bulging contact portion 33A.

### [Configuration of Terminals]

### (Base Materials)

Known materials used as terminal base materials such as copper and copper alloy can be used as the female terminal base material 51 and the male terminal base material 41. Both of these base materials may be made of the same kind of metal or made of different kinds of metals. Further, an intermediate layer made of nickel or the like may be provided on one or both surfaces of the female terminal base material 51 and the male terminal base material 41. By providing the intermediate layer, the hardness, the durability and the like of a plating layer formed thereon can be adjusted and the diffusion of atoms from the base material to the plating layer can be suppressed.

### (Plating Layers)

The first silver plating layer 53 is formed on outermost surfaces of the female terminal base material 51. Note that the outermost surfaces of the female terminal base material 51 mean all the surfaces exposed outside such as the upper, lower and side surfaces and the like of the female terminal base material 51. The first silver plating layer 53 has to be provided at least on the outermost surface of a part of the upper or inner surface (or the surface substantially facing the first contact piece 31) of the bulging contact portion 33A of the second contact piece 33 to be held in contact with the tab piece 21. In this embodiment, the first silver plating layer 53 is formed on the lower or inner surface (or the surface substantially facing the second contact piece 33) of the first contact piece 31 (surface to be held in contact with the tab piece 21) and the upper or inner surface of the second contact piece 33 including the bulging contact portion 33A to cover these outermost surfaces.

On the other hand, the second silver plating layer 43 is formed on outermost surfaces of the male terminal base material 41. The second silver plating layer 43 has to be provided at least over the outermost surface in the entire contact region 21A, which the bulging contact portion 33A of the second contact piece 33 can contact, on the lower surface of the tab 21. In this embodiment, the second silver plating layer 43 is formed to cover the outermost surfaces of the entire upper and lower surfaces of the tab 21.

The first and second silver plating layers 53, 43 can be formed by known methods such as electroplating. The both silver plating layers may be formed by the same method or may be formed by different methods. Further, the both have only to contain silver as a main component and may contain other elements as long as high adhesion property and oxidation resistance peculiar to silver are not impaired. Constituent elements and component compositions of the both silver plating layers may be the same or may be different.

Silver is a relatively soft metal and a Vickers hardness of a silver plating layer depends on a crystal particle diameter and the like and can be controlled such as by adjusting plating conditions. For example, it is known that, if an element such as antimony is added to a plating solution, the crystal growth of silver microcrystals is suppressed and a silver plating layer having a small crystal particle diameter and a high hardness is obtained. Vickers hardnesses of silver plating layers used in general are about 90 to about 100 Hv. Generally, silver plating layers of lower than about 70 Hv are called low-hardness silver plating layers and those of about 110 Hv or higher are called high-hardness silver plating layers.

In the technique disclosed in this specification, the first silver plating layer 53 is formed to have a higher Vickers hardness than the second silver plating layer 43. A Vickers hardness difference between the first and second silver plating layers 53, 43 is about 10 Hv or more, preferably about 15 Hv or more and more preferably about 20 Hv or more in terms of suppressing the abrasion of the first silver plating layer 53 in the contact parts of these silver plating layers. Note that, preferably, the first silver plating layer 53 is a high-hardness silver plating layer having a Vickers hardness of about 110 Hv or higher and the second silver plating layer 43 is a general-purpose silver plating layer having a Vickers hardness of about 100 Hv or lower.

Thicknesses of the first and second silver plating layers 53, 43 are not particularly limited, but are preferably about 1 to about 10 μm in terms of suppressing a cost increase while exhibiting effects of the silver plating layers. The thicknesses of the both silver plating layers may be equal or may be different.

### (Functions and Effects)

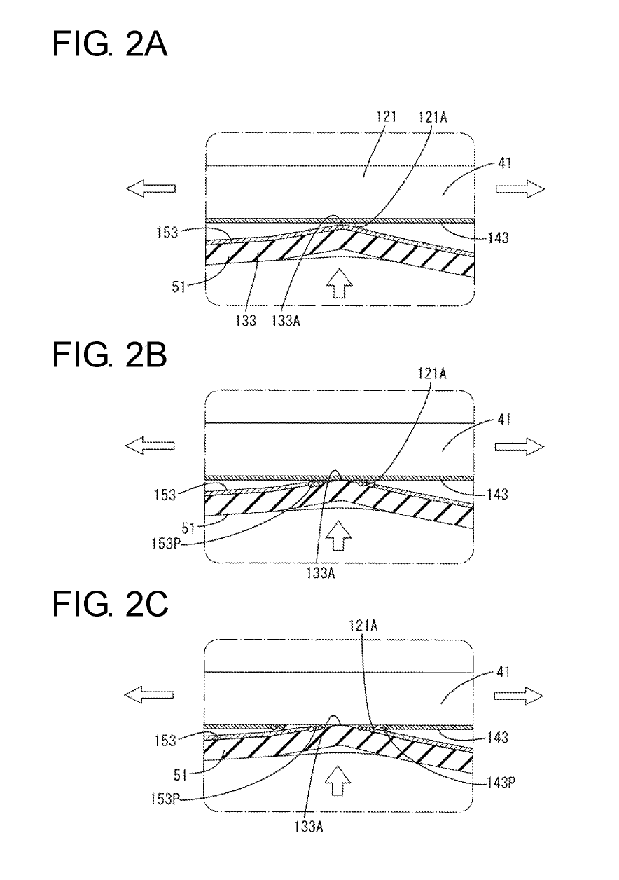

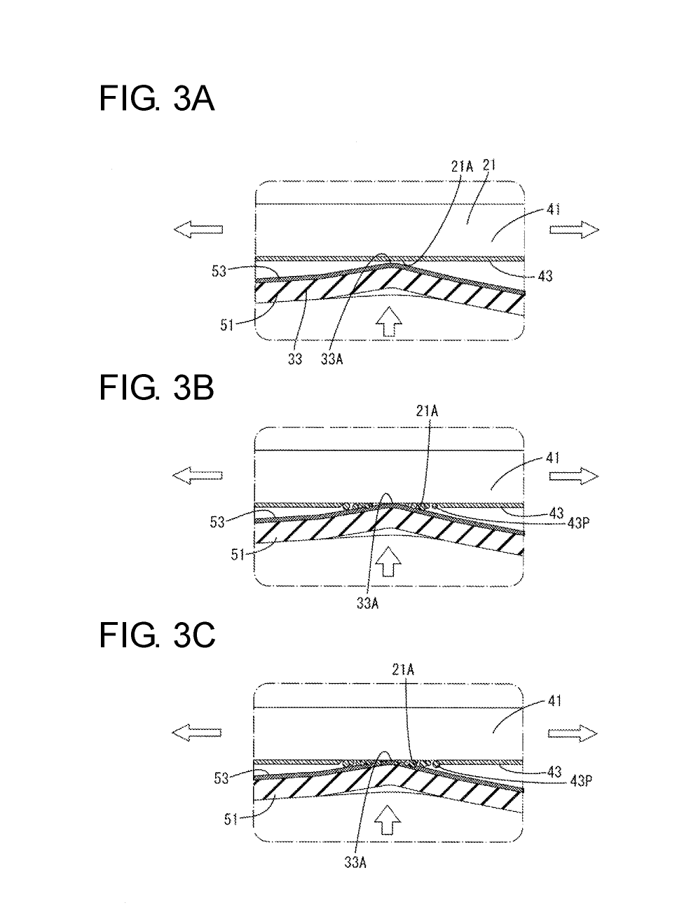

Next, functions and effects of this embodiment are described with reference to FIGS. 2 and 3.

First, a terminal pair in which an outermost surface of a contact region is coated with a second silver plating layer having a Vickers hardness equal to or higher than that of a first silver plating layer coating a contact portion unlike this embodiment is described as a comparative example.

FIGS. 2A-2C schematically show a contact part of a second contact piece 133 including a female terminal base material 51 and a first silver plating layer 153 and a tab 121 including a male terminal base material 41 and a second silver plating layer 143. In this comparative example, the second contact piece 133 and the tab 121 are shaped and structured similarly to the second contact piece 33 and the tab 21 of the embodiment described above. However, in this comparative example, the second silver plating layer 133 coating the male terminal base material 41 is harder than the first silver plating layer 153 coating the female terminal base material 51 and has a higher Vickers hardness than the first silver plating layer 153.

FIG. 2A shows a state immediately before the both terminals come into contact. When the second contact piece 133 is resiliently restored and connected (e.g. crimped) to the tab 121, the bulging contact portion 133A provided on the second contact piece 133 contacts the lower surface of the tab 121 in a contact region 121A. If the vibration of a vehicle is transferred to contact parts of these, the bulging contact portion 133A slides in the contact region 121A and electrical connection is maintained without separation. The bulging contact portion 133A is held in contact with the tab 121 constantly at the same position, the influence of abrasion caused by sliding is partly large as compared to the contact region 121A. Thus, the first silver plating layer 153 is abraded locally earlier as shown in FIG. 2B not only when the second silver plating layer 143 is harder than the first silver plating layer 153 as in this comparative example, but also in a general configuration in which both members are coated with silver plating layers having an equal hardness. Here, since the bulging contact portion 133A is held in contact with the tab 121 constantly at the same position as described above, first silver abrasion powder 153P produced on the bulging contact portion 133A is excluded without staying on the surface of the contact part of the bulging contact portion 133A, thereby reducing electrical conductivity between the terminals. If sliding is repeated, the second silver plating layer 143 is abraded by the exposed female terminal base material 51 and, as shown in FIG. 2C, the male terminal base material 41 also is exposed to cause a contact failure and further reduce conductivity.

In contrast to the above comparative example, the outermost surface of the contact region 21A is coated with the second silver plating layer 43 having a lower Vickers hardness than the first silver plating layer 53 coating the contact portion 33A in this embodiment.

FIGS. 3A-3C are cross sections of the contact parts of the female terminal 10 and the male terminal 20 according to this embodiment. FIG. 3A shows a state immediately before the second contact piece 33 of the female terminal 10 is connected (e.g. crimped) to the tab 21 of the male terminal 20. When the vibration of the vehicle is transferred to the contact parts of the terminals connected (e.g. crimped) to each other by the resilient restoration of the second contact piece 33, the bulging contact portion 33A slides in the contact region 21A.

According to this embodiment, the second silver plating layer 43 coating the outermost surface of the contact region 21A has a lower Vickers hardness than the first silver plating layer 53 coating the bulging contact portion 33A. Thus, if sliding is repeated, the second silver plating layer 43 is abraded earlier to produce second silver abrasion powder 43P on the surface of the contact region 21A, as shown in FIG. 3B. The second silver abrasion powder 43P is attracted toward the first silver plating layer 53 on the surface of the bulging contact portion 33A and stay on the surface of the contact region 21A due to a high adhesion property peculiar to silver. Then, the second silver abrasion powder 43P can fill up abrasion marks of the second silver plating layer 43 and be present between the bulging contact portion 33A and the contact region 21A by entering an interface between the sliding bulging contact portion 33A and the contact region 21A. The second silver abrasion powder 43P remains without being oxidized due to a high oxidation resistance peculiar to silver so that a high conductivity is maintained. Thus, even if sliding is repeated from the state of FIG. 3B, the second silver abrasion powder 43P remaining in the contact parts of the female terminal 10 and the male terminal 20 not only suppresses the abrasion of the first silver plating layer 53 of the bulging contact portion 33A, but also maintains a high electrical conductivity between the terminals, as shown in FIG. 3C.

As described above, according to this embodiment, it is possible to obtain the terminal pair 1 having a high vibration resistance, excellent in connection reliability and simply configured without being accompanied by a drastic cost increase, a shape change and the like by simply coating the outermost surface of the contact region 21A, with which the bulging portion 33A slides in contact, with the second silver plating layer 43 having a lower Vickers hardness than the first silver plating layer 53 coating the outermost surface of the bulging portion 33A.

This is specifically described below based on Examples. Note that the technique disclosed in this specification is not limited by these Examples at all.

### Example 1

Copper alloy base plates having a thickness of about 0.25 mm) were used as the female terminal base material 51 and the male terminal base material 41, and the first silver plating layer 53 and the second silver plating layer 43 were formed on surfaces of these by electroplating. Thicknesses of the first and second silver plating layers 53, 43 were both about 5 μm. When Vickers hardnesses of these silver plating layers 53, 43 were measured as described later, the Vickers hardness of the first silver plating layer was 113 Hv and that of the second silver plating layer was 95 Hv (Vickers hardness of the first silver plating layer>Vickers hardness of the second silver plating layer).

### Comparative Example 1

The same copper alloy base plates having a thickness of about 0.25 mm as those used in Example 1 were used as the female terminal base material 51 and the male terminal base material 41, and the first silver plating layer 153 and the second silver plating layer 143 were formed on surfaces of these to have a thickness of about 5 μm by electroplating as in Example 1. When Vickers hardnesses of these silver plating layers were measured, the Vickers hardness of the first silver plating layer 153 was 60 Hv and that of the second silver plating layer 143 was 95 Hv (Vickers hardness of the first silver plating layer<Vickers hardness of the second silver plating layer).

### [Evaluation]

### [Measurement of Vickers Hardnesses]

The Vickers hardnesses of the first and second silver plating layers 53, 43 on the electrically conductive metal plate materials obtained in Example 1 and Comparative Example 1 were measured according to JIS Z2244:2009 e.g. using a micro surface material property evaluation system “MZT-522” produced by Mitutoyo Corporation.

### (Measurement of Resistance Values in Sliding Abrasion Durability Test)

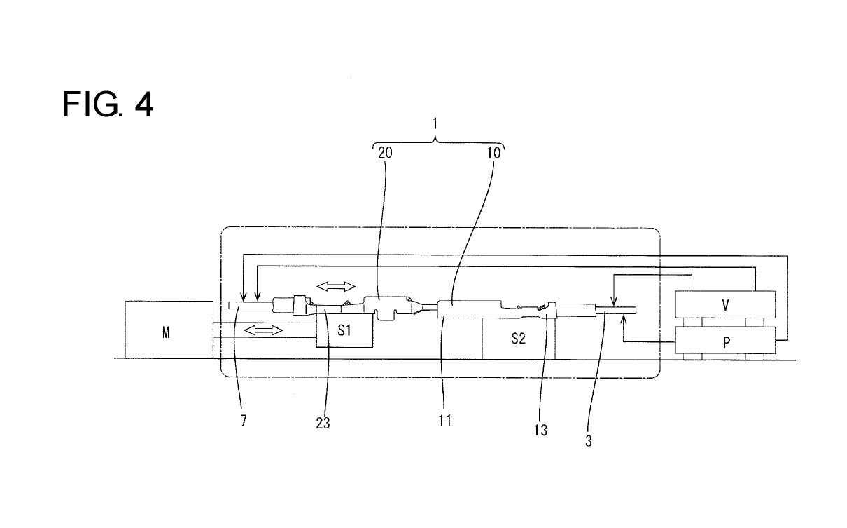

The female terminals 10 and the male terminals 20 were formed using the electrically conductive metal plate materials obtained in Example 1 and Comparative Example 1, and the terminal pairs 1 obtained by connecting these as shown in FIG. 1 were subjected to a sliding abrasion durability test. The test was conducted using a fine sliding abrasion durability measuring device “G04-0705” produced by Aikoh Engineering Co., Ltd. The summary of the test is shown in FIG. 4. First, the wire connecting portion 23 of the male terminal 20 out of the terminal pair 1 is placed on a movable stage S1 and the wire connecting portion 13 of the female terminal 10 was placed on a fixed stage S2 in advance. Note that the tab 21 of the male terminal 20 was inserted and held in the connecting tube 11 of the female terminal 10. In conducting the test, a motor M was driven to slide the movable stage S1 in a front-back direction, a voltage was applied from a DC power supply P connected to the wire 3 on the side of the female terminal 10 and the wire 7 on the side of the male terminal 20 and a voltage was detected by a voltmeter V so that a transition of resistance in relation of the number of times of sliding was measured. A sliding distance was 120 μm and a sliding speed was 1 Hz.

### [Result and Considerations]

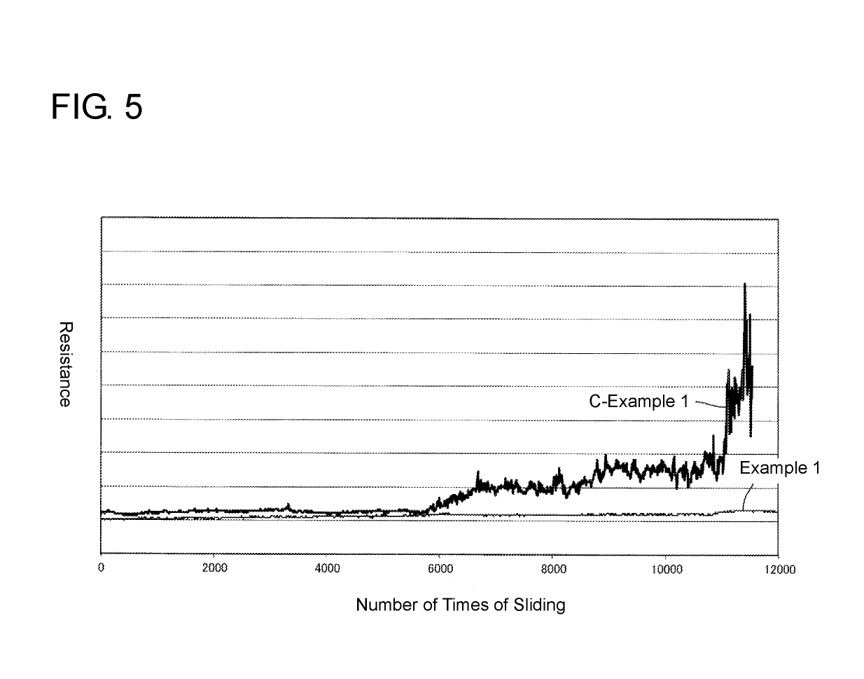

A result obtained by the sliding abrasion durability test is shown in a graph of FIG. 5. It is read from the graph that the resistance started increasing when the number of times of sliding exceeds 6000 times and suddenly increased around 11000 times in Comparative Example 1. In contrast, in Example 1, the resistance was stable at a low value until 12000 times was reached. Specifically, it was confirmed that the terminal pair having a high vibration resistance, excellent in connection reliability and simply configured was obtained according to the configuration of Example 1.

The technique disclosed in this specification is not limited to the above described and illustrated embodiment. For example, the following embodiments are also included in the technical scope of the present invention.

The shapes of the female terminal 10 (first terminal) and the male terminal 20 (second terminal) are not limited. The contact region may be formed on the female terminal 10 and the contact portion may be formed on the male terminal 20. The both terminals may be in point, line or surface contact. Further, the contact of the both terminals is not limited to the resilient contact as described in the above embodiment and, for example, one terminal may be crimped and connected to the other such as by bolt tightening. The terminal pair 1 is not limited to the one in which one terminal is inserted into the other terminal like the female terminal 10 and the male terminal 20 in the above embodiment.

Materials of the female terminal base material 51 and the male terminal base material 41 are not limited. The first and second silver plating layers 53, 43 have only to contain silver as a main component and may include other elements as long as high adhesion property and oxidation resistance peculiar to silver are not impaired.

Metals such as silver, gold, palladium, tin, nickel and alloys of these metals can be appropriately selected for the first and second plating layers according to need. Out of these, one, two or more kinds of metals or these alloys selected from a group composed of silver, gold and palladium are preferable since they are relatively difficult to oxidize and, when abrasion powder of these metals is formed by abrasion between the contact portion and the contact region, the abrasion powder is present between the contact portion and the contact region without being oxidized to maintain electrical connection.

Although the first and second plating layers are silver or silver alloy in the above embodiment, there is no limitation to this and the metal forming the first plating layer and the metal forming the second plating layer may be different.

### REFERENCE SIGNS

1 . . . terminal pair

10 . . . female terminal (first terminal)

20 . . . male terminal (second terminal)

21 . . . tab (insertion piece)

21A . . . contact region

33 . . . second contact piece (resilient piece)

33A . . . bulging contact portion

41 . . . male terminal base material

43 . . . second silver plating layer (second plating layer)

51 . . . female terminal base material

53 . . . first silver plating layer (first plating layer)

What is claimed is:

1. A terminal pair (1), comprising:
a first terminal (10) provided with a contact portion (33); and
a second terminal (20) provided with a contact region (21A) wider than the contact portion (33),
the contact portion (33) of the first terminal (10) being configured to contact the second terminal (20) in the contact region (21A) to electrically connect the first and second terminals (10, 20) to each other, wherein:
an outermost surface of the contact portion (33) at least partly is coated with a first plating layer (53); and
an outermost surface of the contact region (21A) at least partly is coated with a second plating layer (43) having a lower Vickers hardness than the first plating layer.

2. The terminal pair of claim 1, wherein metals forming the first and second plating layer (53, 43) are one, two or more kinds of metals selected from a group consisting of silver, gold and palladium or alloys thereof.

3. The terminal pair of claim 1, wherein the metal forming the first and second plating layers (53, 43) is silver or silver alloy.

4. The terminal pair of claim 1, wherein a difference between a Vickers hardness of the first plating layer (53) and that of the second plating layer (43) is about 10 Hv or more.

5. The terminal pair of claim 4, wherein the Vickers hardness of the first plating layer (53) is about 110 Hv or higher and that of the second plating layer (43) is about 100 Hv or lower.

6. The terminal pair of claim 1, wherein the contact portion (33A) is in line or point contact with the contact region (21A) when the first and second terminals (10, 20) are connected to each other.

7. The terminal pair of claim 1, wherein:
the second terminal (20) is a male terminal (10) including an insertion piece (21) provided with the contact region (21A);
the first terminal (10) is a female terminal (10) including a resilient piece (33) provided with the contact portion (33A), the insertion piece (21) being at least partly insertable into the female terminal (20); and
the resilient piece (33) resiliently contacts the insertion piece (21) at least partly inserted into the female terminal (20).

8. The terminal pair of claim 1, wherein the first plating layer (53) and/or the second silver plating layer (43) has a thickness in the range of about 1 to about 10 μm.

9. A connector with the terminal pair of claim 1, comprising:
a first connector housing configured to accommodate the first terminal (10); and
a second connector housing connectable to the first connector housing and configured to accommodate the second terminal (20).
